(19) United States
(12) Patent Application Publication
(10) Pub. No.: US 2015/0259596 A1
(43) Pub. Date: Sep. 17, 2015

(54) TITANATE LUMINESCENT MATERIAL AND PREPARATION METHOD THEREOF

(71) Applicants: Mingjie Zhou, Shenzhen (CN); Rong Wang, Shenzhen (CN)

(72) Inventors: Mingjie Zhou, Shenzhen (CN); Rong Wang, Shenzhen (CN)

(73) Assignees: Ocean's King Lighting Science & Technology Co.,Ltd, Shenzhen (CN); Shenzhen Ocean's King Lighting Engineering Co.,Ltd, Shenzhen (CN)

(21) Appl. No.: 14/427,362

(22) PCT Filed: Sep. 11, 2012
(86) PCT No.: PCT/CN2012/081235

§ 371 Date: May 20, 2015

(51) Int. Cl. C09K 11/87; C09K 11/02; C09K 11/77

(52) U.S. Cl. CPC C09K 11/87; C09K 11/77; C09K 11/02

(57) ABSTRACT

The present invention relates to a titanate luminescent material and preparation method thereof. The titanate luminescent material has the following chemical formula: Ca₁₋ₓTi_{1-y}O₃:Prₓ,R_{y}@TiO₂@M_{z}, wherein @ represents coating, M_{z} is a core, TiO₂ is an intermediate shell; Ca₁₋ₓTi_{1-y}O₃:Prₓ,R_{y}, is an outer shell, Prₓ and R_{y} are doped in Ca₁₋ₓTi_{1-y}O₃; R is at least one of Al and Ga, and M is at least one of Ag, Au, Pt Pd and Cu metallic nanoparticles; 0<x≦0.01, 0<y≦0.20, z is a molar ratio between M and the element Ti in the titanate luminescent material, 0<z≦1×10⁻². The titanate luminescent material is formed into a core-shell structure by doping a charge compensation agent such as ions Al³⁺, Ga³⁺ and the like, and encapsulating metallic nanoparticles, thus effectively improving the luminous efficiency of the titanate luminescent material. In addition, the titanate luminescent material has the advantages of good stability and good luminous performance, and thus can be used as a red luminescent material in a cathode ray device. Moreover, the preparation method of the titanate luminescent material is of a simple technique, is pollution free and easy to control, has low requirement for device, and is suitable for industrial production.

### FIELD OF THE INVENTION

The present disclosure relates to the field of luminescent materials, and more particularly relates to a titanate luminescent material and preparation method thereof.

BACKGROUND OF THE INVENTION

Red phosphors include several material categories such as sulfides, oxides, sulfur oxides and titanates. Among them, the titanate material has many advantages such as high stability, good color rendering properties, or the like, such that it can be applied to situations demanding a high working stability of phosphor, e.g., field emission display used under a low voltage and high current density. As a typical titanate material, CaTiO₃:Pr has a CIE chromaticity coordinates of x=0.680 and y=0.311, which, is very close to ideal red, thus it is an ideal phosphor.

However, the conventional titanate materials usually have structural defects, for example, in the CaTiO₃:Pr material, since Ca²⁺ ions at A position in the Perovskite structure is replaced by luminescence center Pr³⁺ ion, Ca²⁺ ions vacancies defects and oxygen vacancies defects may be easily formed, which leads to an increasing risk of non-radiative transition and a reducing of luminous efficiency of Pr³⁺ ions. Therefore, the CaTiO₃:Pr materials exist the problem of the low luminous efficiency, which limits the practical application of the CaTiO₃:Pr materials.

### SUMMARY OF THE INVENTION

Accordingly, it is necessary to provide a titanate luminescent material having a higher luminous efficiency.

A titanate luminescent material has the following chemical formula:

Ca₁₋ₓTi_{1-y}O₃:Prₓ,R_{y}@TiO₂@M_{z};
wherein @ represents coating, Pr and R are doped in Ca₁₋ₓTi_{1-y}O₃, M forms a core of the titanate luminescent material, TiO₂ forms an intermediate shell of the titanate luminescent material; Ca₁₋ₓTi_{1-y}O₃:Prₓ,R_{y}, forms an outer shell of the titanate luminescent material; R is at least one selected from the group consisting of Al and Ga, and M is at least one metallic nanoparticle selected from the group consisting of Ag, Au, Pt, Pd and Cu; 0<x≦0.01, 0<y≦0.20, z is a molar ratio between M and Ti in the titanate luminescent material, 0<z≦1×10⁻².

In one embodiment, 0.001≦x≦0.005.

In one embodiment, 0.02≦y≦0.15.

In one embodiment, 1×10⁻⁵≦y≦5×10⁻³.

In the titanate luminescent material, a charge compensation Al³⁺ or Ga³⁺ is doped to replace Ti⁴⁺ ion at B position, such that the structural defect of the titanate luminescent material is effectively solved, and the probability of non-radiative transition is reduced, thus enhancing the luminous efficiency. In addition, by coating metal nanopaticles to form a core-shell structure, the titanate luminescent material exhibits a greatly increased luminous efficiency without changing the wavelength of the emitted light under the same excitation conditions due to the surface plasma effect of metal nanoparticles. The titanate luminescent material described above exhibits many advantages such as high luminous efficiency, good stability, high light performance, such that it has broad practical application prospects.

Additionally, it is necessary to provide a method of preparing the titanate luminescent material having a higher luminous efficiency.

A method of preparing a titanate luminescent material includes the following steps:
mixing and reacting a salt solution of the metal M, an organic titanium compound, and a first reducing agent to obtain a colloid of TiO₂@M_{z} having a core-shell structure, wherein the salt solution of the metal M and the organic titanium compound are mixed according to a mole ratio z of M to titanium, 0<z≦1×10⁻², M is at least one selected from the group consisting of Ag, Au, Pt, Pd and Cu, @ represents coating, M forms a core of the core-shell structure, TiO₂ forms an intermediate shell of the core-shell structure;
preparing an ethanol aqueous solution containing Ca²⁺, R³⁺, and Pr³⁺ according to mole ratio of Ca²⁺, R³⁺, and Pr³⁺ of (1−x):x:y; wherein R³⁺ is at least one selected from the group consisting of Al³⁺ and Ga⁺, 0<x≦0.01; 0<y≦0.20;
adding a second reducing agent and a surfactant to the ethanol aqueous solution containing Ca²⁺, R³⁺, and Pr³⁺, stirring at 60° C. to 80° C. for 2 to 6 hours to obtain a sol;
adding the TiO₂@M_{z} solid to the sol, stirring at 60° C. to 80° C. for 2 to 12 hours to obtain a precursor solution, wherein a mole ratio of the TiO₂@M_{z} to Ca²⁺ in the sol is (2−y):(1−x);
drying the precursor solution to obtain a gel; and
grinding the gel, preheating the gel at 500° C. to 700° C. for 1 to 6 hours, grinding the gel again after cooling, calcining the gel at 700° C. to 1200° C. for 1 to 10 hours to obtain a titanate luminescent material having the following chemical formula: Ca₁₋ₓTi_{1-y}O₃:Prₓ,R_{y}@TiO₂@M_{z}; wherein Pr and R are doped in Ca₁₋ₓTi_{1-y}O₃, M forms a core of the titanate luminescent material, TiO₂ forms an intermediate shell of the titanate luminescent material; Ca₁₋ₓTi_{1-y}O₃:Prₓ,R_{y}, forms an outer shell of the titanate luminescent material.

In one embodiment, the salt solution of the metal M is at least one solution selected from the group consisting of HAuCl₄, AgNO₃, H₂PtCl₆, PdCl₂, and Cu(NO₃)₂ having a concentration of 5×10⁻⁵ mol/L to 5×10⁻³ mol/L.

In one embodiment, the organic titanium compound is titanium isopropoxide triethanolamine; the First reducing agent is dimethyl formamide, the first reducing agent is 20% to 80% by volume of a total volume of the first reducing agent, the salt solution of the metal M, and the organic titanium compound.

In one embodiment, the ethanol aqueous solution containing Ca²⁺, R³⁺, and Pr³⁺ is an ethanol aqueous solution containing acetate, hydrochloride or nitrate or Ca²⁺, R³⁺, and Pr³⁺, and a volume ratio of ethanol to water in the ethanol aqueous solution ranges from 3:1 to 8:1.

In one embodiment, the surfactant is a polyethylene glycol having a molecular weight of 100 to 20000.

In the method of preparing the titanate luminescent material, the M metal ion in the salt solution of the metal M. is firstly reduced to M. elemental metal in the presence of a reducing agent, then the M elemental metal is used as a core, the organic titanium compound hydrolyzes slowly on the surface of the elemental metal to form a TiO₂ shell to encapsulate metal M, thus obtaining TiO₂@M. Finally, a sol-gel method is performed using TiO₂@M as a Ti source compound with the compounds corresponding to Ca, R, and Pr to prepare the titanate luminescent material coating metal nanoparticles, i.e., Ca₁₋ₓTi_{1-y}O₃:Prₓ,R_{y}@TiO₂@M_{z}. The above preparation method, is simple, low requirement on equipment, pollution-free, easy to control, and is suitable for industrial production. The obtained titanate luminescent material has a core-shell structure, and exhibits a high luminous efficiency, such that it has broad practical application prospects.

### BRIEF DESCRIPTION OF THE DRAWINGS

FIG. 1 is a flow chat of a method of preparing a titanate luminescent material according to an embodiment;

FIG. 2 is a graphical representation of cathodoluminescence spectrum under a voltage of 3 kV of the fluorescent material of Ca_{0.998}Ti_{0.9}O₃:Pr_{0.002},Al_{0.1}@TiO₂@Ag_{5×10}−4 coating metal nanopaticle Ag prepared in accordance with Example 2 and the fluorescent material of Ca_{0.998}Ti_{0.9}O₃:Pr_{0.002};Al_{0.1}@TiO₂ without coating metal nanoparticles.

### DETAILED DESCRIPTION OF THE EMBODIMENTS

Reference will now be made to the drawings to describe, in detail, embodiments of the present titanate luminescent material, and preparation method thereof.

According to an embodiment, a titanate luminescent material is provided having the following chemical formula: Ca₁₋ₓTi_{1-y}O₃:Prₓ,R_{y}@TiO₂@M_{z}, where @ represents coating, Pr and R are doped in Ca₁₋ₓTi_{1-y}O₃. M forms a core of the titanate luminescent material, TiO₂ forms an intermediate shell of the titanate luminescent material; Ca₁₋ₓTi_{1-y}O₃:Prₓ,R_{y}, forms an outer shell of the titanate luminescent material, R is at least one selected from the group consisting of Al and Ga. M is at least one nanoparticle selected from the group consisting of Ag, Au, Pt, Pd and Cu, 0<x≦0.01, preferably 0.001≦x≦0.005. 0<y≦0.20, preferably 0.02≦y≦0.15. z is a molar ratio between M and Ti in the titanate luminescent material, 0<z≦1×10⁻², preferably 1×10⁻⁵≦y≦5×10⁻³.

In the titanate luminescent material, the charge compensation Al³⁺ or Ga³⁺ is doped to replace Ti⁴⁺ ion at B position, such that the structural defect of the titanate luminescent material is effectively solved, and the probability of non-radiative transition is reduced, thus enhancing the luminous efficiency. In addition, by encapsulating metal nanopaticles to form a core-shell structure, the titanate luminescent material exhibits a greatly increased luminous efficiency without changing the wavelength of the emitted light under the same excitation conditions due to the surface plasma effect of metal nanoparticles. The titanate luminescent material described above exhibits many advantages such as high luminous efficiency, good stability, high light performance, such that it has broad practical application prospects.

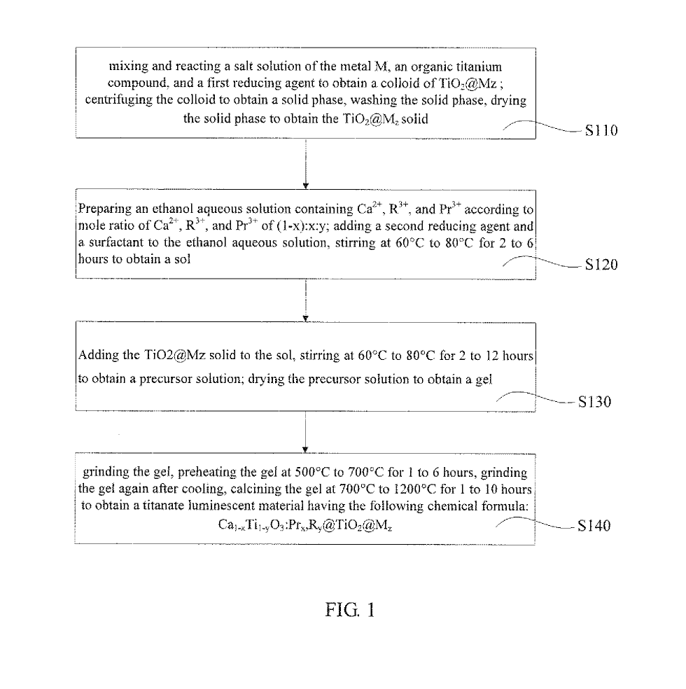

Referring to FIG. 1, an embodiment of a method of preparing the titanate luminescent material is provided, which includes the following steps:

Step S110, a salt solution of the metal M, an organic titanium compound, and a first reducing agent are mixed and reacted to obtain a colloid of TiO₂@M_{z} having a core-shell structure, the colloid is centrifuged to obtain a solid phase, which, is then washed, dried to obtain the TiO₂@M_{z} solid. The salt solution, of the metal M and the organic titanium compound are mixed according to a mole ratio z, which is a mole ratio of M to titanium, 0<z≦1×10⁻², M is at least one selected from the group consisting of Ag, Au, Pt, Pd and Cu, @ represents coating, M forms a core of the core-shell structure, TiO₂ forms an intermediate shell of the core-shell structure.

In the present embodiment, the salt solution of the metal M is at least one solution selected from the group consisting of HAuCl₄, AgNO₃, H₂PtCl₆, PdCl₂, and Cu(NO₃)₂ having a concentration of 5×10⁻⁵ mol/L to 5×10⁻³ mol/L. Specifically, at least one of the AgNO₃. AuCl₃·HCl·4H₂O, H₂PtCl₆·6H₂O. PdCl₂·2H₂O, Cu(NO₃)₂ can be added to deionized water or ethanol, uniformly stirred, and the metal M salt solution can be obtained.

In the present embodiment, the organic titanium compound is triethanolamine titanium isopropoxide. The first reducing agent is dimethyl formamide (DMF). The adding amount of the first reducing agent, i.e. DMF, is 20% to 80%, preferably 25% to 50% by volume of a total volume of the first reducing agent, the salt solution of the metal M, and the organic titanium compound.

Step S120, an ethanol aqueous solution containing Ca²⁺, R³⁺, and Pr³⁺ is prepared according to mole ratio of Ca²⁺, R³⁺, and Pr³⁺ of (1−x):x:y, a second reducing agent and a surfactant are added to the ethanol aqueous solution containing Ca⁺, R³⁺ and Pr³⁺, stirred at 60° C. to 80° C. for 2 to 6 hours to obtain a sol. R³⁺ is at least one selected from the group consisting of Al³⁺ and Ga³⁺, 0<x≦0.01; 0<y≦0.20.

In the present embodiment, the ethanol aqueous solution containing Ca²⁺, R³⁺, and Pr³⁺ is an ethanol aqueous solution containing acetate, hydrochloride or nitrate of Ca²⁺, R³⁺, and Pr³⁺. For example, oxide or carbonate of Ca, R and Pr can be used as a raw material, which is dissolved in hydrochloric acid or nitric acid, and then a mixture of ethanol and water is added to prepare the ethanol. aqueous solution. Alternatively, acetate, hydrochloride or nitrate of Ca, R and Pr can be used directly as the raw material, which is dissolved in a mixture of ethanol and water to prepare the ethanol aqueous solution. In the present embodiment, a volume ratio of ethanol to water in the ethanol aqueous solution ranges from 3:1 to 8:1.

In the present embodiment, the second reducing agent is citric acid, and a mole ratio of the second reducing agent to a sum of the Ca²⁺, R³⁺, and Pr³⁺ ranges from. 1:1 to 5:1. The surfactant is a polyethylene glycol having a molecular weight of 100 to 20000, preferably 2000 to 10000.

Step S130, the TiO₂@M_{z} solid is added to the sol, stirred at 60° C. to 80° C. for 2 to 12 hours to obtain a precursor solution. The precursor solution is then dried to obtain a gel. A mole ratio of the adding amount of the TiO₂@M_{z} to Ca²⁺ in the sol is (2−y):(1−x); where 0<x≦0.01; 0<y≦0.20.

Step S140, the gel is ground, preheated at 500° C. to 700° C. for 1 to 6 hours, ground again after cooling, calcinined at 700° C. to 1200° C. for 1 to 10 hours to obtain a titanate luminescent material having the following chemical formula: Ca₁₋ₓTi_{1-y}O₃:Prₓ,R_{y}@TiO₂@M_{z}; where Pr and R are doped in Ca₁₋ₓTi_{1-y}O₃, M forms a core of the titanate luminescent material, TiO₂ forms an intermediate shell of the titanate luminescent material, and Ca₁₋ₓTi_{1-y}O₃:Prₓ,R_{y}, forms an outer shell of the titanate luminescent material.

In the method of preparing the titanate luminescent material, the M metal ion in the salt solution of the metal M is firstly reduced to M elemental metal in the presence of a reducing agent, then the M elemental metal is used as a core, the organic titanium compound hydrolyzes slowly on the surface of the elemental metal to form a TiO₂ shell to encapsulate metal M, thus obtaining TiO₂@M. Finally, a sol-gel method is performed using TiO₂@M as a Ti source compound with the compounds corresponding to Ca, R, and Pr to prepare the titanate luminescent material coating metal nanoparticles, i.e., Ca₁₋ₓTi_{1-y}O₃:Prₓ,R_{y}@TiO₂@M_{z}. The above preparation method is simple, low requirement on equipment, pollution-free, easy to control, and suitable for industrial production. The obtained titanate luminescent material has a core-shell structure and exhibits a high luminous efficiency, such that it has broad practical application prospects.

The titanate luminescent material with different composition and preparation method, as well, as performance test, will be described with reference to specific examples.

### EXAMPLE 1

Preparation of Ca_{0.999}Ti_{0.98}O₃:Pr_{0.001},Al_{0.02}@TiO₂@Au_{1×10}⁻² using sol-gel method.

Preparation of TiO₂@Au_{1×10}⁻²: 10.3 mg of chloroauric acid (AuCl₃·HCl·4H₂O) was weighed and dissolved into deionized water to prepare 20 mL of chloroauric acid solution having a concentration of 5×10⁻³ mol/L. 5 mL of triethanolamine titanium isopropoxide with a concentration of 4.3 mol/L was pipette and diluted with isopropyl alcohol to 1 mol/L. 10 mL of 5×10⁻³ mol/L of chloroauric acid solution and 5 mL of 1 mol/L of isopropyl alcohol solution of titanium isopropoxide triethanolamine were pipette and well mixed to form a mixed solution. 15 mL of dimethylformamide was added to the mixed solution, stirred at a room temperature for 15 minutes, the heated and stirred at 140° C. using a reflux device. When the color of solution turned light brown through colorless and turned dark brown, the heating was stopped, the system was cooled to the room temperature, and TiO₂@Au_{1×10}_{^{−}}₂ colloid was obtained. The colloid was then centrifuged, rinsed with ethanol and dried, and TiO₂@Au_{1×10}₂ solid was obtained.

Preparation of titanate luminescent material of Ca_{0.999}Ti_{0.98}O₃:Pr_{0.001},Al_{0.02}@TiO₂@Au_{1×10}−2: 0.7900 g of calcium acetate (Ca(CH₃COO)₂), 0.0204 g of aluminum acetate (Al(CH₃COO)₃), and 0.0016 g of praseodymium acetate (Pr(CH₃COO)₃) were weighed and placed in a vessel, 50 mL of mixed solution of ethanol and water with a volume ratio of 4:1 was added. 1.9212 g of citric acid and 2.5 g of polyethylene glycol having a relative molecular weight of 100 were added to the vessel in an 80° C. water bath with stirring, the reaction system was stirred for 2 hours to obtain a transparent sol. 0.3914 g of TiO₂@Au_{1×10}_{^{−}}₂ powder was added, stirred for 2 hours to obtain a precursor sol. The precursor sol was then dried for 20 hours at a temperature of 70° C., a xerogel was obtained after the solvent is volatized. The obtained xerogel was ground to powder, calcined in a high temperature box furnace at 600° C. for 2 hours, cooled and ground again, calcined at 900° C. for 4 hours, cooled to the room temperature to obtain the titanate luminescent material having the formula of Ca_{0.999}Ti_{0.98}O₃:Pr_{0.001},Al_{0.02}@TiO₂@Au_{1×10}−2.

### EXAMPLE 2

Preparation of Ca_{0.998}Ti_{0.9}O₃:Pr_{0.002},Al_{0.1}@TiO₂@Ag_{5×10}−4 using sol-gel method.

Preparation of TiO₂@Au_{1×10}−4: 3.4 mg of silver nitrate (AgNO₃) was weighed and dissolved into deionized water to prepare 20 mL of silver nitrate solution having a concentration of 1×10⁻³ mol/L. 10 mL of triethanolamine titanium isopropoxide with a concentration, of 4.3 mol/L was pipette and diluted with isopropyl alcohol to 0.22 mol/L. 2 mL of 1×10⁻³mol/L of silver nitrate solution and 18 mL of 1 mol/L of isopropyl alcohol solution of titanium isopropoxide triethanolamine were pipette and well mixed to form a mixed solution. 10 mL of dimethylformamide was added to the mixed solution, stirred at a room temperature for 15 minutes, the heated and stirred at 140° C. using a reflux device. When the color of solution turned light brown through colorless and turned dark brown, the heating was stopped, the system was cooled to the room temperature, and TiO₂@Au_{5×10}−4 colloid was obtained. The colloid was then centrifuged, rinsed with ethanol and dried, and TiO₂@Au_{5×10}−4 solid was obtained.

Preparation of titanate luminescent material of Ca_{0.998}Ti_{0.9}O₃:Pr_{0.002},Al_{0.1}@TiO₂@Ag_{5×10}−4: 1.6375 g of calcium nitrate (Ca(NO₃₎₂), 0.2129 g of aluminum nitrate (Al(NO₃)₃), and 0.0065 g of praseodymium nitrate (Pr(NO₃)₃) were weighed and placed in a vessel, 50 mL of mixed solution of ethanol and water with a volume ratio of 3:1 was added. 7.6848 g of citric acid and 5 g of polyethylene glycol having a relative molecular weight of 10000 were added to the vessel in an 80° C. water bath with stirring, the reaction system was stirred for 4 hours to obtain a transparent sol. 0.7189 g of TiO₂@Au_{5×10}−4 powder was added, stirred for 6 hours to obtain a precursor sol. The precursor sol was then dried for 10 hours at a temperature of 100° C., a xerogel was obtained after the solvent is volatized. The obtained xerogel was ground to powder, calcined in a high temperature box furnace at 700° C. for 4 hours, cooled and ground again, calcined at 1000° C. for 4 hours, cooled to the room temperature to obtain the titanate luminescent material having the formula of Ca_{0.998}Ti_{0.9}O₃:Pr_{0.002},Al_{0.1}@TiO₂@Ag_{5×10}−4.

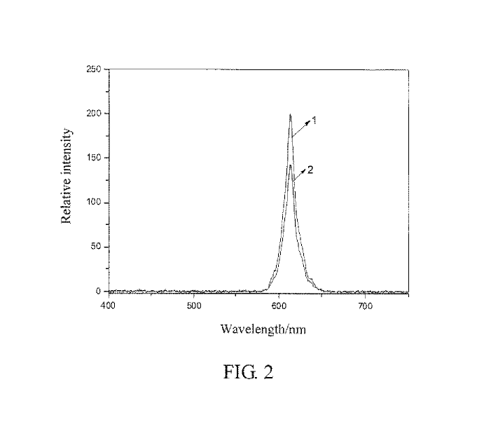

FIG. 2 is a graphical representation, of cathodoluminescence spectrum under a voltage of 3 kV of the fluorescent material of Ca_{0.998}Ti_{0.9}O₃:Pr_{0.002},Al_{0.1}@TiO₂@Ag_{5×10}−4 coating metal nanopaticle Ag prepared in accordance with Example 2 and the fluorescent material of Ca_{0.998}Ti_{0.9}O₃:Pr_{0.002},Al_{0.1}@TiO₂ without coating metal nanoparticles. It can be seen from FIG. 2 that, at an emission peak of 612 nm, the emission intensity of luminescent material coating metal nanoparticles is enhanced by 40% comparing to commercial phosphor. Accordingly, the luminescent material according to Example 2 has a good stability, good color purity and high luminous efficiency.

### EXAMPLE 3

Preparation of Ca_{0.995}Ti_{0.85}O₃:Pr_{0.005},Ga_{0.15}@TiO₂@Pt_{5×10}−3 using sol-gel method.

Preparation of TiO₂@Pt_{5×10}−3: 25.9 mg of chloroplatinic acid (H₂PtCl₆·6H₂O) was weighed and dissolved into deionized water to prepare 10 mL of chloroplatinic acid solution having a concentration of 2.5×10⁻³ mol/L. 5 mL of triethanolamine titanium isopropoxide with a concentration of 4.3 mol/L was pipette and diluted with isopropyl. alcohol to 0.5 mol/L. 8 mL of 2.5×10⁻³ mol/L of chloroplatinic acid solution and 16 mL of 0.5 mol/L of isopropyl alcohol solution of titanium isopropoxide triethanolamine were pipette and well mixed to form a mixed solution. 6 mL of dimethylformamide was added to the mixed solution, stirred at a room temperature for 15 minutes, the heated and stirred at 140° C. using a reflux device. When the color of solution turned light brown through colorless and turned dark brown, the heating was stopped, the system was cooled to the room temperature, and TiO₂@Pt_{5×10}−3 colloid was obtained. The colloid was then centrifuged, rinsed with ethanol and dried, and TiO₂@Pt_{5×10}−3 solid was obtained.

Preparation of titanate luminescent material of Ca_{0.995}Ti_{0.85}O₃:Pr_{0.005},Ga_{0.15}@TiO₂@Pt_{5×10}−3: 0.2789 g of calcium oxide (CaO), 0.0703 g of gallium oxide (Ga₂O₃), and 0.0043 g of praseodymium oxide (Pr₆O₁₁) were weighed and placed in a vessel, 1 mL of concentrated nitric acid and 3 mL of deionized water were dissolved by heating in the vessel, and 50 mL of mixed solution of ethanol and water with a volume ratio of 3:1 was added after cooling. 9.6060 g of citric acid and 2.75 g of polyethylene glycol having a relative molecular weight of 200 were added to the vessel in an 80° C. water bath with stirring, the reaction system was stirred for 1 hour to obtain a transparent sol. 0.3395 g of TiO₂@Pt_{5×10}−3 powder was added, stirred for 12 hours to obtain a precursor sol. The precursor sol was then dried for 6 hours at a temperature of 150° C., a xerogel was obtained after the solvent is volatized. The obtained xerogel was ground to powder, calcined in a high temperature box furnace at 500° C. for 6 hours, cooled and ground again, calcined at 1200° C. for 1 hour, cooled to the room temperature to obtain the titanate luminescent material having the formula of Ca_{0.995}Ti_{0.85}O₃:Pr_{0.005},Ga_{0.15}@TiO₂@Pt_{5×10}−3.

### EXAMPLE 4

Preparation of Ca_{0.99}Ti_{0.92}O₃:Pr_{0.01},Ga_{0.08}@TiO₂@Pd_{1×10}−5 using sol-gel method.

Preparation of TiO₂@Pd_{1×10}−5: 0.22 mg of palladium chloride (PdCl₂·2H₂O) was weighed and dissolved into deionized water to prepare 20 mL of palladium chloride solution having a concentration of 5×10⁻⁵ mol/L. 10 mL of triethanolamine titanium isopropoxide with a concentration of 4.3 mol/L was pipette and diluted with isopropyl alcohol to 2.5 mol/L. 5 mL of 5×10⁻⁵ mol/L of palladium chloride solution and 10 mL of 2.5 mol/L of isopropyl alcohol solution of titanium isopropoxide triethanolamine were pipette and well mixed to form a mixed solution. 5 mL of dimethylformamide was added to the mixed solution, stirred at a room temperature for 15 minutes, the heated and stirred at 140° C. using a reflux device. When the color of solution turned light brown through colorless and turned dark brown, the heating was stopped, the system was cooled to the room temperature, and TiO₂@Pd_{1×10}−5 colloid was obtained. The colloid was then centrifuged, rinsed with ethanol and dried, and TiO₂@Pd_{1×10}−5 solid was obtained.

Preparation of titanate luminescent material of Ca_{0.99}Ti_{0.92}O₃:Pr_{0.01},Ga_{0.08}@TiO₂@Pd_{1×10}−5: 0.4954 g of calcium carbonate (Ca₂O₃), 0.0639 g of gallium carbonate (Ga₂(CO₃)₃), and 0.0115 g of praseodymium carbonate (Pr₂(CO₃)₃) were weighed and placed in a vessel, 5 mL of dilute nitric acid was dissolved by heating in the vessel, and 50 mL of mixed solution of ethanol and water with a volume ratio of 3:1 was added after cooling. 5.3793 g of citric acid and 8.25 g of polyethylene glycol having a relative molecular weight of 2000 were added to the vessel in an 65° C. water bath with stirring, the reaction system was stirred for 6 hour to obtain a transparent sol. 0.3858 g of TiO₂@Pd_{1×10}−5 powder was added, stirred for 4 hours to obtain a precursor sol. The precursor sol was then dried for 8 hours at a temperature of 100° C., a xerogel was obtained after the solvent is volatized. The obtained xerogel was ground to powder, calcined in a high temperature box furnace at 700° C. for 1 hour, cooled and ground again, calcined at 900° C. for 10 hours, cooled to the room temperature to obtain the titanate luminescent material having the formula of Ca_{0.99}Ti_{0.92}O₃:Pr_{0.01},Ga_{0.08}@TiO₂@Pd_{1×10}−5.

### EXAMPLE 5

Preparation of Ca_{0.996}Ti_{0.80}O₃:Pr_{0.004},Al_{0.10},Ga_{0.10}@TiO₂@Cu_{1×10}−4 using sol-gel method.

Preparation of TiO₂@Cu_{1×10}−4: 1.6 mg of copper nitrate (Cu(NO₃)₂) was weighed and dissolved into 16 mL of ethanol to prepare 20 mL of copper nitrate solution having a concentration of 4×10⁻⁴ mol/L. 5 mL of triethanolamine titanium isopropoxide with a concentration of 4.3 mol/L was pipette and diluted with isopropyl alcohol to 2 mol/L. 2 mL of 4×10⁻⁴ mol/L of copper nitrate solution and 4 mL of 2 mol/L of isopropyl alcohol solution of titanium isopropoxide triethanolamine were pipette and well mixed to form a mixed solution. 24 mL of dimethylformamide was added to the mixed solution, stirred at a room temperature for 15 minutes, the heated and stirred at 140° C. using a reflux device. When the color of solution turned light brown through colorless and turned dark brown, the heating was stopped, the system was cooled to the room temperature, and TiO₂@Cu_{1×10}−4 colloid was obtained. The colloid was then centrifuged, rinsed with ethanol and dried, and TiO₂@Cu_{1×10}−4 solid was obtained, where y=1×10⁻⁴.

Preparation of titanate luminescent material of Ca_{0.996}Ti_{0.80}O₃:Pr_{0.004},Al_{0.10},Ga_{0.10}@TiO₂@Cu_{1×10}−4: 0.5527 g of calcium chloride (CaCl₂), 0.0666 g of aluminum chloride (AlCl₃), 0.0880 g of praseodymium chloride (PrCl₃), and 0.0049 g of praseodymium chloride (PrCl₃) were weighed and placed in a vessel, 50 mL of mixed solution of ethanol and water with a volume ratio of 4:1 was added. 6.9163 g of citric acid and 2.5 g of polyethylene glycol having a relative molecular weight of 20000 were added to the vessel in a 60° C. water bath with stirring, the reaction system was stirred for 3 hours to obtain a transparent sol. 0.3514 g of TiO₂@Cu_{1×10}−4 powder was added, stirred for 12 hours to obtain a precursor sol. The precursor sol was then dried for 15 hours at a temperature of 80° C., a xerogel was obtained after the solvent is volatized. The obtained xerogel was ground to powder, calcined in a high temperature box furnace at 500° C. for 3 hours, cooled and ground again, calcined at 700° C. for 5 hours, cooled to the room temperature to obtain the titanate luminescent material having the formula of Ca_{0.996}Ti_{0.80}O₃:Pr_{0.004},Al_{0.10},Ga_{0.10}@TiO₂@Cu_{1×10}−4.

### EXAMPLE 6

Preparation of Ca_{0.994}Ti_{0.88}O₃:Pr_{0.006},Al_{0.12}@TiO₂@(Ag_{0.5}/Au_{0.5})_{1.25×10}−4 using sol-gel method.

Preparation of TiO₂@(Ag_{0.5}/Au_{0.5})_{1.25×10}−4: 6.2 mg of chloroauric acid (AuCl₃·HCl·4H₂O) and 2.5 mg of AgNO₃ were weighed and dissolved into 28 mL of deionized water to prepare 30 mL of mixed solution of chloroauric acid and silver nitrate having a total concentration of 5×10⁻³ mol/L (the concentrations of chloroauric acid and silver nitrate are 0.5×10⁻³ mol/L, respectively). 2 mL of triethanolamine titanium isopropoxide with a concentration of 4.3 mol/L was pipette and diluted with isopropyl alcohol to 0.4 mol/L. 5 mL of 1×10⁻³ mol/L of mixed solution of chloroauric acid and silver nitrate and 10 mL of 0.4 mol/L of isopropyl alcohol solution of titanium isopropoxide triethanolamine were pipette and well mixed to form a mixed solution. 10 mL of dimethylformamide was added to the mixed solution, stirred at a room temperature for 15 minutes, the heated and stirred at 140° C. using a reflux device. When the color of solution turned light brown through colorless and turned dark brown, the heating was stopped, the system, was cooled to the room temperature, and TiO₂@(Ag_{0.5}/Au_{0.5})_{1.25×10}−4 colloid was obtained. The colloid was then centrifuged, rinsed with ethanol and dried, and TiO₂@(Ag_{0.5}/Au_{0.5})_{1.25×10}−4 solid was obtained.

Preparation of titanate luminescent material of Ca_{0.994}Ti_{0.88}O₃:Pr_{0.006},Al_{0.12}@TiO₂@(Ag_{0.5}/Au_{0.5})_{1.25×10}−4: 0.8155 g of calcium nitrate (Ca(NO₃)₂), 0.1278 g of aluminum nitrate (Al(NO₃)₃), and 0.0098 g of praseodymium nitrate (Pr(NO₃)₃) were weighed and placed in a vessel, 50 mL of mixed solution of ethanol. and water with, a volume ratio of 3:1 was added. 9.2217 g of citric acid and 5.5 g of polyethylene glycol having a relative molecular weight of 4000 were added to the vessel in an 70° C. water bath with stirring, the reaction system was stirred for 4 hours to obtain a transparent sol. 0.3690 g of TiO₂@(Ag_{0.5}/Au_{0.5})_{1.25×10}−4 powder was added, stirred for 6 hours to obtain a precursor sol. The precursor sol was then dried for 12 hours at a temperature of 100° C., a xerogel was obtained after the solvent is volatized. The obtained xerogel was ground to powder, calcined in a high temperature box furnace at 600° C. for 1 hour, cooled and ground again, calcined at 800° C. for 8 hours, cooled to the room temperature to obtain the titanate Luminescent material having the formula of Ca_{0.994}Ti_{0.88}O₃:Pr_{0.006},Al_{0.12}@TiO₂@(Ag_{0.5}/Au_{0.5})_{1.25×10}−4.

Although the present invention has been described with reference to the embodiments thereof and the best modes for carrying out the present invention, it is apparent to those skilled in the art that a variety of modifications and changes may be made without departing from the scope of the present invention, which is intended to be defined by the appended claims.

1. A titanate luminescent material having the following chemical formula:
Ca₁₋ₓTi_{1-y}O₃:Prₓ,R_{y}@TiO₂@M_{z};
wherein @ represents coating, Pr and R are doped in Ca₁₋ₓTi_{1-y}O₃, M forms a core of the titanate luminescent material, TiO₂ forms an intermediate shell of the titanate luminescent material; Ca₁₋ₓTi_{1-y}O₃:Prₓ,R_{y}, forms an outer shell of the titanate luminescent material; R is at least one selected from the group consisting of Al and Ga, and M is at least one nanoparticle selected from the group consisting of Ag, Au, Pt, Pd and Cu; 0<x≦0.01, 0<y≦0.20, z is a molar ratio between M and Ti in the titanate luminescent material, 0<z≦1×10⁻².

2. The titanate luminescent material according to claim 1, wherein 0.001≦x≦0.005.

3. The titanate luminescent material according to claim 1, wherein 0.02≦y≦0.15.

4. The titanate luminescent material according to claim 1, wherein 1×10⁻⁵≦z≦5×10⁻³.

5. A method of preparing a titanate luminescent material, comprising the following steps:
mixing and reacting a salt solution of the metal M, an organic titanium compound, and a first reducing agent to obtain a colloid of TiO₂@M_{z} having a core-shell structure, wherein the salt solution of the metal M and the organic titanium compound are mixed according to a mole ratio z of M to titanium, 0<z≦1×10⁻², M is at least one selected from the group consisting of Ag, Au, Pt, Pd and Cu, @ represents coating, M forms a core of the core-shell structure, TiO₂ forms an intermediate shell of the core-shell structure;
centrifuging the colloid to obtain a solid phase, washing the solid phase, drying the solid phase to obtain the TiO₂@M_{z} solid;
preparing an ethanol aqueous solution containing Ca²⁺, R³⁺, and Pr³⁺ according to mole ratio of Ca²⁺, R³⁺, and Pr³⁺ of (1−x):x:y; wherein R³⁺ is at least one selected from the group consisting of Al³⁺ and Ga³⁺, 0<x≦0.01; 0<y≦0.20;
adding a second reducing agent and a surfactant to the ethanol aqueous solution containing Ca²⁺, R³⁺, and Pr³⁺, stirring at 60° C. to 80° C. for 2 to 6 hours to obtain a sol;
adding the TiO₂@M_{z} solid to the sol, stirring at 60° C. to 80° C. for 2 to 12 hours to obtain a precursor solution, wherein a mole ratio of the TiO₂@M_{z} to Ca²⁺ in the sol is (2−y):(1−x);
drying the precursor solution to obtain a gel; and
grinding the gel, preheating the gel at 500° C. to 700° C. for 1 to 6 hours, grinding the gel again after cooling, calcining the gel at 700° C. to 1200° C. for 1 to 10 hours to obtain a titanate luminescent material having the following chemical formula: Ca₁₋ₓTi_{1-y}O₃:Prₓ,R_{y}@TiO₂@M_{z}, wherein Pr and R are doped in Ca₁₋ₓTi_{1-y}O₃, M forms a core of the titanate luminescent material, TiO₂ forms an intermediate shell of the titanate luminescent material; Ca₁₋ₓTi_{1-y}O₃:Prₓ,R_{y}, forms an outer shell of the titanate luminescent material.

6. The method according to claim 5, wherein the salt solution of the metal M is at least one solution selected from the group consisting of HAuCl₄, AgNO₃, H₂PtCl₆, PdCl₂, and Cu(NO₃)₂ having a concentration of 5×10⁻⁵mol/L to 5×10⁻³ mol/L.

7. The method according to claim 5, wherein the organic titanium compound is titanium isopropoxide triethanolamine; the first reducing agent is dimethyl formamide, the first reducing agent is 20% to 80% by volume of a total volume of the first reducing agent, the salt solution of the metal M, and the organic titanium compound.

8. The method according to claim 5, wherein the ethanol aqueous solution containing Ca²⁺, R³⁺, and Pr³⁺ is an ethanol aqueous soiution containing acetate, hydrochloride or nitrate or Ca²⁺, R³⁺, and Pr³⁺, and a volume ratio of ethanol to water in the ethanol aqueous solution ranges from 3:1 to 8:1.

9. The method according to claim 5, wherein the second reducing agent is citric acid, and a mole ratio of the second reducing agent to a sum of the Ca²⁺, R³⁺, and Pr³⁺ ranges from 1:1 to 5:1.

10. The method according to claim 5, wherein the surfactant is a polyethylene glycol having a molecular weight of 100 to 20000.
